(19) United States
(12) Patent Application Publication
(10) Pub. No.: US 2025/0004856 A1
(43) Pub. Date: Jan. 2, 2025

(54) TECHNIQUES FOR FIXING CONFIGURATION MISALIGNMENT OF CLOUD RESOURCES

(71) Applicant: Go Firefly Ltd., Tel Aviv (IL)

(72) Inventors: Sefi GENIS, Ramat Gan (IL); Eran BIBI, Nes Tziona (IL)

(73) Assignee: Go Firefly Ltd., Tel Aviv (IL)

(21) Appl. No.: 18/344,440

(22) Filed: Jun. 29, 2023

(51) Int. Cl. G06F 9/50

(52) U.S. Cl. CPC G06F 9/5077; G06F 9/5072

(57) ABSTRACT

A method and system for correcting misaligned states of cloud resources in a cloud infrastructure are provided. The method includes receiving a first list of cloud resources and their current operational states in a cloud infrastructure; retrieving, from at least one IaC tool, a second list cloud resources and their deployed states; for each cloud resource includes in the first list and second list, comparing its current operational state to its deployed state to identify a misaligned state, wherein a misaligned state of a cloud resource is when its current operational state differs from its deployed state; for each cloud resource identified with a misaligned, generating a configuration code to fix the identified misaligned cloud resource; and causing the IaC tool to apply the generated configuration code on each misaligned cloud resource, thereby causing the current operational state to match the deployed state of the misaligned cloud resource.

### TECHNICAL FIELD

The present disclosure relates generally to cloud computing infrastructure, and more specifically to fixing configuration misalignment of cloud resources in cloud infrastructure.

### BACKGROUND

Infrastructure-as-Code (IaC) refers to managing and provisioning cloud infrastructure using machine-readable configuration files or scripts. An IaC stack is a cloud computing environment where infrastructure management is performed through code.

IaC tools eliminate the need to configure and manage cloud resources manually but rather configure and define the desired state of cloud resources using code. Such code is typically written in a declarative language, allowing to specify the desired configuration and relationships between various resources. IaC code can be version-controlled, shared, and collaborated on using code repositories' tools.

IaC tools can automatically create, modify, and destroy cloud resources, but such tools cannot guarantee consistent and reliable configuration or state of cloud resources. As a prime example, consistency and reliability issues not efficiently resolved by existing IaC tools are often referred to as drift or configuration misassignment. A drift or misalignment defines a situation when the current operational configuration or state of the cloud resource (and hence the infrastructure) differs from the configuration or state initially defined and deployed by an IaC tool. Misalignment may occur, for example, due to changing resource definitions manually or by other IaC tool(s). A misalignment in the cloud infrastructure can also occur when resources fail, are terminated, or are simply not managed by IaC tools.

Cloud infrastructure drift or misalignment can lead to a number of problems. One of the significant problems is operational, which may arise if, for example, compute power of a resource has been manually reduced, which could cause issues for services or applications relying on that resource. Another problem is security, as, for example, changes made manually can open up vulnerabilities that can be exploited. Additionally, there can be monetary problems if resources are not being used efficiently, for instance, if a virtual machine's memory allocation has been doubled without good reason, it could increase costs unnecessarily.

Existing IaC tools, such as Terraform may detect drifts in cloud resources and apply a fix on such resources. However, the applied fixed is limited to reconfiguring the state of a drifted cloud resource to its initial state as currently maintained by the IaC tool. Thus, existing IaC tools merely override the current state of a drifted resource with the initially configured state. Such a solution does not solve the problems mentioned above. For example, if the compute power of a resource has been manually increased to meet additional demand for a service, scaling back to the original configuration (i.e., less compute power) may lead to an unavailable service.

Another limitation of existing IaC tools in fixing drifted cloud resources is that they are limited to fixing exclusively managed resources. That is, if a resource is not managed by any IaC tool, such resource cannot be fixed for drift or misalignment. Further, a resource managed by one IaC tool (e.g., CloudFormation) cannot be fixed by another IaC tool (e.g., Terraform).

Another limitation of existing IaC tools in fixing drifted cloud resources is the privileges given to such tools in order to apply the fixes. The privileges are often unrestricted, allowing a user of an IaC tool to apply any changes to the cloud infrastructure, intentionally or unintentionally. Beyond any security concerns, unrestricted privileges can result in a complete demand for the cloud infrastructure.

It would therefore be advantageous to provide a solution that allows for better, faster, more objective, and more accurate automated techniques for fixing configuration misalignments of cloud resources.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

In one general embodiment, method may include receiving a first list of cloud resources and their current operational states in a cloud infrastructure. Method may also include retrieving, from at least one IaC tool, a second list cloud resources and their deployed states. Method may furthermore include for each cloud resource includes in the first list and second list, comparing its current operational state to its deployed state to identify a misaligned state, where a misaligned state of a cloud resource is when its current operational state differs from its deployed state. Method may in addition include for each cloud resource identified with a misaligned, generating a configuration code to fix the identified misaligned cloud resource. Method may moreover include causing the IaC tool to apply the generated configuration code on each misaligned cloud resource, thereby causing the current operational state to match the deployed state of the misaligned cloud resource. Other embodiments of this aspect include corresponding computer systems, apparatus, and computer programs recorded on one or more computer storage devices, each configured to perform the actions of the methods.

Implementations may include one or more of the following features: saving the generated configuration code in a code repository associated with the IaC tool, where generating the configuration code further may include: mapping, for managed cloud resources, between configuration code stored in the code repository and to the deployed state managed by the at least one IaC tool; and mapping, for managed cloud resources, between configuration code stored in the code repository and to the operation state as in the cloud infrastructure. Implementations of the described techniques may include hardware, a method or process, or a computer tangible medium.

In one general embodiment, a system may include a processing circuitry. System may also include a memory, the memory containing instructions that, when executed by the processing circuitry, configure the system to: receive a first list of cloud resources and their current operational states in a cloud infrastructure. System may in addition include retrieve, from at least one IaC tool, a second list cloud resources and their deployed states. System may moreover include for each cloud resource includes in the first list and second list, compare its current operational state to its deployed state to identify a misaligned state, where a misaligned state of a cloud resource is when its current operational state differs from its deployed state. System may also include for each cloud resource identified with a misaligned, generate a configuration code to fix the identified misaligned cloud resource. System may furthermore include cause the IaC tool to apply the generated configuration code on each misaligned cloud resource, thereby causing the current operational state to match the deployed state of the misaligned cloud resource.

Implementations may include one or more of the following features of the system: save the generated configuration code in a code repository associated with the IaC tool. System where the system is further configured to: map, for managed cloud resources, between configuration code stored in the code repository and to the deployed state managed by the at least one IaC tool; and map, for managed cloud resources, between configuration code stored in the code repository and to the operation state as in the cloud infrastructure. Implementations of the described techniques may include hardware, a method or process, or a computer tangible medium. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe various disclosed embodiments.

FIG. 2 is a flowchart of an example method for detecting and correcting misaligned cloud resources according to an embodiment.

FIG. 3 is a flowchart of an example process for generating fixes for misaligned cloud resources.

FIG. 4 is an example schematic diagram of an IaC correction server according to an embodiment.

### DETAILED DESCRIPTION

The various disclosed embodiments include methods and systems for fixing drifts or misalignments (collectively referred to as “misalignments” or “misalignment”) in the configurations or states (collectively referred to as “states” or “state”) of cloud resources or a cloud resource, in a cloud infrastructure. A misalignment defines a situation when the current operational state of a cloud resource (and hence the infrastructure) differs from the state initially defined and deployed by an IaC tool.

According to the disclosed embodiments, misalignments may be detected and corrected in any state initially defined and deployed by any type IaC tool and/or a plurality of different IaC tools. The detection is performed by obtaining the current operational states of cloud resources in a cloud infrastructure. This can be achieved by querying the cloud infrastructure, scanning for resources and their states in the cloud infrastructure, and/or retrieving the resources and their states for external systems monitoring the cloud infrastructure. The current operational states of cloud resources are compared to their initial states and deployed by one or more IaC tools.

Upon detection of misalignment resulting from the comparison, a fix is generated so that the deployed state by an IaC(s) tool will match the current operational state of a misaligned cloud resource. That is, the generated fix changes the state of the IaC tool. In an embodiment, the generated fix is a code compliant with the IaC environment and saved in a code repository accessible by the IaC tool. The disclosed embodiments further allow to automatically cause the IaC tool to apply the fix on the misaligned resources in the cloud infrastructure.

The disclosed process for detecting and fixing misalignments in the states of cloud resources is performed while maintaining restricted access permissions of an IaC tool to the cloud infrastructure. Thus, the disclosed solution increases the security protection of the cloud infrastructure.

It should be noted that the techniques disclosed herein allow users (e.g., DevOps, Platform and/or SRE personnel) to ensure that the current operational state of a cloud resource is being deployed. A user may opt not to apply the generated fix, thereby forcing a change in a resource's state to its deployed initial state. As such, the cloud infrastructure would be configured to its optimal configuration. Therefore, the disclosed embodiments and techniques increase the cloud infrastructure's efficiency, operation, and security compared to solutions discussed in the related art.

In addition to the other benefits described herein, the disclosed embodiments and techniques allow for optimizing the cost of utilizing cloud resources as such resources would be deployed to optimal states of their consumed compute power. Further, other benefits include optimal operations of software applications, services, and the like on the cloud infrastructure as the cloud resources are deployed to their optimal operational state.

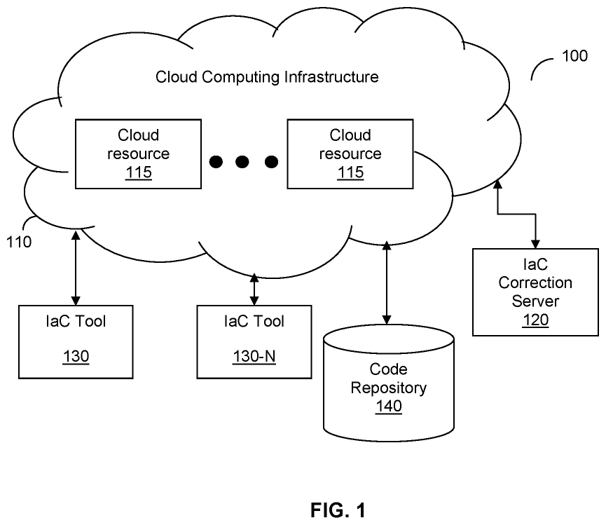

FIG. 1 is an example network diagram 100 utilized to describe various disclosed embodiments.

The network diagram 100 depicts a cloud infrastructure 110, an IaC correction server (or simply “the server”) 120 configured to communicate with cloud resources 115 deployed in the cloud infrastructure 110. The network diagram 100 also depicts IaC tools 130-1 through 130-N (where N is an integer having a value equal to or greater than 1), communicate with the cloud infrastructure 110, and a code repository 140. The cloud infrastructure 110 may include a private cloud platform, a public cloud platform, a hybrid cloud platform, or any combination thereof. For example, the cloud infrastructure 110 may include Amazon Web Services (AWS), Microsoft Azure, and the like. The cloud infrastructure 110 further includes container services (such as Kubernetes), and SaaS applications, version control systems, and the like.

A cloud resource 115 may include any compute or storage resource, object, or instance deployed in a cloud infrastructure 110. A cloud resource 115 may include a virtual machine, a container, or storage, such as object storage (e.g., Amazon S3, Google Cloud Storage), block storage (e.g., Amazon EBS, Azure Disk Storage), file storage (e.g., Amazon EFS, Azure Files), a database (e.g., Amazon RDS, Azure SQL Database, Amazon DynamoDB, Google Cloud Firestore, Amazon ElastiCache, Azure Cache for Redis), a load balancer, a content delivery network (CDN), a serverless function, virtual networks, subnets, firewalls, Virtual Private Network (VPN) gateways, ingress, egress, deployments, alerts, dashboard, branch, and the like.

Every cloud resource 115 can be configured with a set of properties determining its operation and/or compute power consumption. Such properties may differ from one type of resource to another, and further from one type of infrastructure to another. The values of such properties determine the state of the cloud resource 115. Examples of a cloud resource's 115 properties may include, for example, type, size, networking settings, storage settings, security settings (e.g., Identity and Access Management (IAM) role, security group, key pair, etc.), tags, and so on. A cloud resource 115 may further include objects from container systems (e.g., Kubernetes), observability solution systems, and version control systems and repositories.

The state of a cloud resource 115 is determined when deployed by an IaC tool 130 and can be later modified or adjusted by a user or a different IaC tool 130. It should be noted that a cloud resource 115 is typically instantiated on demand. When instantiated, the state of a cloud resource is set according to the deployed state as managed by an IaC tool. In some instances, there may be a subset of cloud resources 115 that are not managed by any of the IaC tool 130. In an embodiment, the server 120 is configured to detect such resources 115, generate a fix (configuration code), and apply such fix on the misaligned resource by the IaC tool 130.

An IaC tool 130 is configured to eliminate the need to manually configure and manage cloud resources, but rather configure and define the desired state of cloud resources using code. Such code is typically written in a declarative language, allowing to specify the desired configuration and relationships between various resources. IaC code can be version-controlled, shared, and collaborated on using code repositories' tools.

An IaC tool 130 provides a way to define and manage infrastructure resources across different cloud providers using code, offering a unified approach to infrastructure management in multi-cloud or hybrid cloud environments. Some examples of IaC tools 130 used in the cloud computing industry include Terraform, AWS CloudFormation, Azure Resource Manager, Google Cloud Deployment Manager, Helm Charts, Pulumi, CrossPlane, and the like.

The code repository 140 may include a distributed version control system (such as, Git, GitLab, or BitBucket). The code repository 140 can be used for storing code and tracking changes in source code during software development.

According to the disclosed embodiments, the server 120 is configured to execute the embodiments and techniques for detecting cloud resources 115 with misaligned states and generate fixes for such misalignments. The fixes are code, generally provided in declarative language compliant with a language used by the IaC tool 130. The fixes are saved in the code repository 140.

In an embodiment, server 120 is configured to receive or obtain a list of resources and their states, detect misalignments with their respective deployed states, and provide fixes for misalignments. The detection of misalignments includes identifying a subset of managed cloud resources 115, i.e., cloud resource 115 managed by one of the IaC tools 130 and comparing the respective operational state to the deployed state. If their states differ, then a misalignment is detected. In an embodiment, all cloud resources identified as unmanaged are considered misaligned, and a fix may be generated. In an embodiment, the server 120 is further configured to cause the IaC tool to apply a fix on each cloud resource identified as a misaligned configuration. The fix is a piece of IaC code that, when applied, modifies the cloud resource's variables as they are in their current operational state.

According to the disclosed embodiments, the server 120 is configured to analyze the current state of a cloud resource (determined to be misaligned) to identify dependencies for other cloud resources. For each dependent resource, a fix (i.e., IaC code) is also generated. In an embodiment, to generate a fix, the current state of a cloud resource is converted into an intermediate representation (e.g., JSON format) that includes language constructs of a declarative or programming language utilized by an IaC tool 130 that apply the fix. Then, the intermediate representation is converted or compiled into a declarative or programming language utilized by an IaC tool 130. For example, if the IaC tool 130 is Terraform, the intermediate representation is a JavaScript Object Notation (JSON) format, and the declarative language is the Terraform language. The generated fix is stored and managed in the code repository 140. The operation of the server 120 will be discussed in detail below.

It should be noted that the server 120 can be realized as a physical machine, a virtual machine that can be deployed in the cloud 110, a different cloud, or on-premises. It should be further noted that the elements shown in FIG. 1 may be connected via the Internet, or any other networks (not shown). Such networks may include, but are not limited to, a wireless, cellular or wired network, a local area network (LAN), a wide area network (WAN), a metro area network (MAN), the Internet, the worldwide web (WWW), similar networks, and any combination thereof.

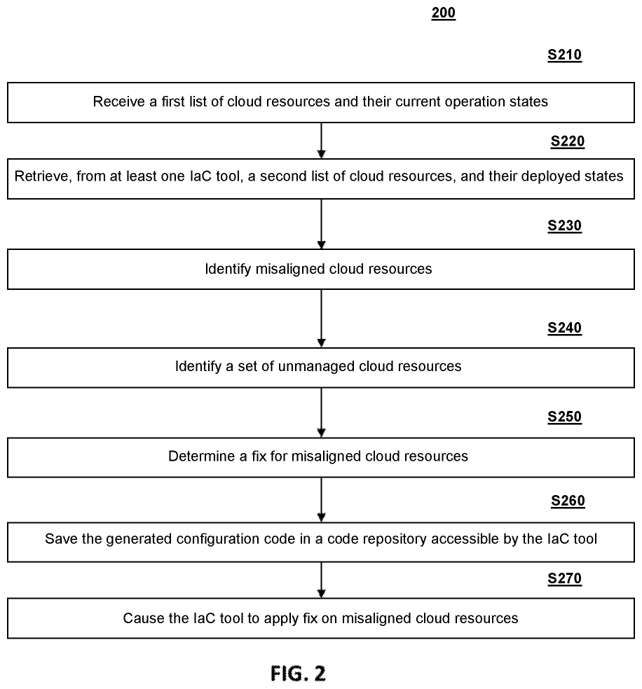

FIG. 2 is an example flowchart of a method 200 for detecting and correcting misaligned cloud resources according to an embodiment. In some implementations, the method of FIG. 2 may be performed by a server or device, such as the server 120 (FIG. 1).

As shown in FIG. 2, method 200 may include receiving a first list of cloud resources and their current operational states (S210). It should be noted that the retrieved information at S210 may not necessarily be organized in a list, and other data structures are applicable. The cloud resources and their current operational states can be retrieved by querying the cloud infrastructure, e.g., via a IaC orchestrator, scanning the cloud infrastructure, or retrieving the cloud resources and their state from an external system or a database (that is not an IaC tool). It should be noted that S210 is required to provide a complete status of the cloud resources and their current optional states. As noted above, a current operating state may differ from its deployed state (applied by an IaC tool).

Furthermore, some cloud resources included in the retrieved information may not be managed by the IaC tool. It should be noted that a cloud resource may include any compute, memory, storage object, entity, instance, and the like deployed in cloud infrastructures, SaaS-data bases platforms, open-source platforms, and the like. Examples of which include Kubernetes, and SaaS Solution such as GitHub, Okta, Akamai, DataDog, CloudFlare, and the like. The state of the cloud resource determines its configuration and operation. Examples of these are provided above.

At S220, a second list of cloud resources and their deployed states is retrieved from one or more IaC tools managing resources in the cloud infrastructure. A deployed state of a cloud resource determines its configuration and operation as initially defined as set, e.g., by a DevOps, Cloud Platform, SRE, personnel. The cloud resources and their deployed states can be retrieved by querying the IaC tools. The format of the deployed states may be in an intermediate representation, such as but not limited to JSON. It should be noted that the retrieved information at S220 may not be necessarily organized in a list, and other data structures are applicable.

At S230, cloud resources with drifts or misaligned states (hereinafter “misaligned cloud resources” or “misaligned cloud resource”) are identified. A misaligned cloud resource is a cloud resource that has a current operational state which differs from its deployed state.

In an embodiment, S230 may include comparing the first and second lists to identify misaligned cloud resources. To this end, according to some example embodiments, the state of each cloud resource in the first list is converted to an intermediate representation compliant with an IaC tool. For example, if the second list includes information retrieved from Terraform, the states designated in the first list are converted into a JSON format which is the intermediate representation compliant with Terraform. Then, for each cloud resource in the first list, its current operational state in the intermediate representation is compared to its respective deployed state included in the second list. If a mismatch is found, the cloud resource is determined or identified as misaligned. It should be noted that the misalignment may be in the variables' values of a cloud resource, as such properties' values determine its state.

Following is a snippet of a state of a cloud resource in AWS managed by Terraform in a JSON format:

```
[
  “ec2:CreateNetworkInterface”,
  “ec2:DescribeNetworkInterfaces”,
  “ec2:DeleteNetworkInterface”,
  “logs:CreateLogStream”,
  “logs:PutLogEvents”,
  “logs:CreateLogGroup”
]
```

The above code is used to define a cloud resource of type “subnet.” The following is code in JSON of the same resource as deployed in the cloud infrastructure:

```
[
  “ec2:CreateNetworkInterface”,
  “ec2:DescribeNetworkInterfaces”,
  “ec2:DeleteNetworkInterface”,
  “logs:CreateLogStream”,
  “logs:PutLogEvents”,
]
```

Comparison of the above code snippets would show that the line “logs:CreateLogGroup” is missing. Therefore, the respective cloud resource would be determined as misaligned cloud resources.

At S240, a subset of unmanaged cloud resources is identified by comparing the first and second lists. The unmanaged cloud resources are resources in the cloud infrastructure not managed by an IaC tool. All unmanaged cloud resources are considered misaligned cloud resources.

At S250, for each misaligned cloud resource, a fix is generated or otherwise determined. A fixed is a configuration code that, when applied or executed, causes modification of a state of the misaligned cloud resource. In an embodiment, upon modification, the deployed state of a misaligned cloud resource would match its current operational state. It should be noted that the fix is generated in a programming or declarative language compliant with an IaC tool (resulting in the misalignment). For example, if the IaC tool is Terraform, the fix will be generated in a Terraform language. The process for generating a fix is discussed below.

At S260, the generated fix is saved in a code repository that can be accessed by an IaC tool. This ensures that the most current version of the fix's configuration code is applied by the IaC for future deployments. This is a critical implementation in a cloud infrastructure where the cloud resources may become active or inactive on demand.

At S270, a command is generated for the IaC tool to apply the fixes on misaligned cloud resources. Thus, executing the generated command would cause the IaC tool to apply the fix's configuration code on each misaligned cloud resource, thereby causing the current operational state to match the deployed state. In an embodiment, a user may select which misaligned cloud resources to apply the generated command.

Although FIG. 2 shows example steps of blocks of the method 200, in some implementations, method 200 may include additional blocks, fewer blocks, different blocks, or differently arranged blocks than those depicted in FIG. 2. Additionally, or alternatively, two or more of the blocks or steps of method 200 may be performed in parallel.

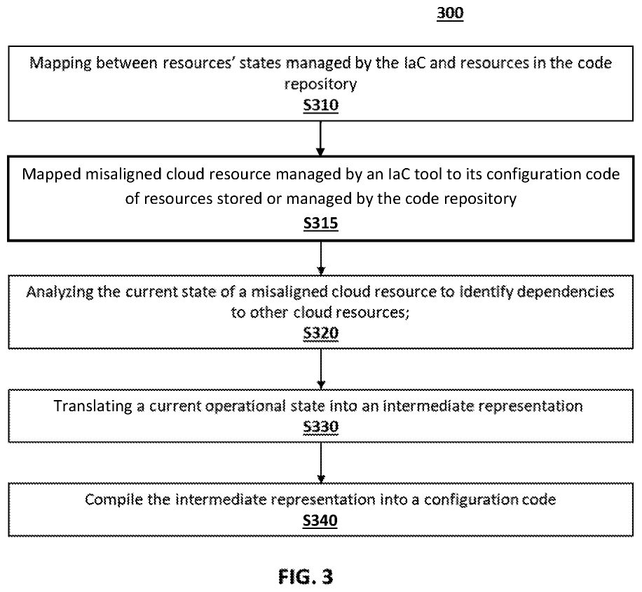

FIG. 3 is a flowchart of an example process S240 for generating fixes for misaligned cloud resources. Process S240 may include additional implementations, such as any single implementation or any combination of implementations described below and/or in connection with one or more other processes described elsewhere herein.

At S310, each misaligned cloud resource managed by an IaC tool is mapped to its respective cloud resource as deployed in the cloud infrastructure. Such link is required to apply the fix to the correct resource managed by the IaC tool. In an embodiment, such link is by comparing the intermediate representation of the cloud resource deployed in the cloud to the IaC state. In some configurations, the mapping information is retrieved and maintained when comparing the first and second links of cloud resources as discussed above.

At S315, each misaligned cloud resource managed by an IaC tool is mapped to its respective configuration code of resources stored or managed by the code repository. The mapping is performed in part to link between the configuration code in the repository and the state of a respective cloud resource. Thus, when a fix should be stored in the repository, such a fix will be placed in the right place, and its version will be correctly updated in the repository.

In an embodiment, S315 includes searching for the code repository using a unique identifier of a misaligned cloud resource. Such a unique identifier may, for example, be a name, a type, or any other identifier string. For example, in AWS such a unique identifier is an Amazon Resource Name (ARN). In another embodiment, the unique identifier may be generated as a concatenation of a number of parameters, such as a resource type, a region, and ID (e.g., ARN). Then, the unique identifier is served as input to a static code analysis process utilizes to search the repository of the configuration code of the resource. The static code analysis process may be a process or program designed to analyze computer programs performed without executing them. In this embodiment, the static code analysis process allows to identify the configuration code and properties of a cloud resource as stored and managed in a code repository. In an embodiment, S310 also includes converting the configuration code from the repository to an intermediate representation to allow comparison to the code as managed by the IaC tool.

It should be noted that S310 and S315 can be performed in different orders or in parallel. In the conclusion of S310 and S315, there is a link of a misaligned cloud resource as appears in the code repository, the IaC tool, and cloud infrastructure. At S320, the code represents the current operational state of a misaligned cloud resource and is analyzed to identify any dependent cloud resources. A dependent cloud resource is a resource that is to be deployed after a different resource. For example, a logical SQL server before deploying a database. In an example embodiment, S320 includes searching the code that represents the current operational state for any points, calls, or references for other cloud resources. A fix is generated for the misaligned and dependent cloud resources. For example, the following code shows the state of a cloud resource “asw_subnet” in a Terraform code. Here, the dependent resource is “aws_vpc”.

```
resource “aws_subnet” “SefiGis-PrivateSubnetB-a80” {
  cidr_block =  “10.0.3.0/24”
  private_dns_hostname_type_on_launch = “ip-name”
  tags = {
    Name  = “SefiGis-PrivateSubnetB”
    environment = “se-assignment”
  }
  vpc_id = “${aws_vpc.SEVPC-SefiGis-6e8.id}”
}
```

In the above example, the cloud resource “aws_subnet” is a resource that depends on a VPC type resource “SEVPC-SefiGis-6e8”. It should be noted that the dependent resources can be unmanaged dependent resources. For example, the VPC resource “SEVPC-SefiGis-6e8” is an unmanaged resource.

At S330, the current operational state is converted into an intermediate representation. Alternatively, if such representation is already available (e.g., from S220), S330 includes retrieving such representation. For example, the intermediate representation is JSON format supported or compliant with the IaC tool. In an example embodiment, S330 may include determining the desired structure of the JSON object. JSON typically includes key-value pairs, where the key is a string, and the value can be a string, number, Boolean, array, or another JSON object. S330 may further include parsing the code of the current operational state and extracting properties and their values, this may include manipulating the parsed data or selecting specific properties names. The process S330 further includes creating a JSON object and populating the JSON objects with the extracted properties and their values. Finally, the JSON object can be validated to ensure it conforms to JSON syntax rules. For example, the following code snippet is the configuration code of a subnet in AWS. The code can be stored in the code repository:

“Ipv6Addresses”: [ ],
“MacAddress”: “02:70:5e:1c:37:49”,
“NetworkInterfaceId”: “eni-010c14a083c8eaeeb”,
“OwnerId”: “106510118456”,
“PrivateDnsName”: “ip-10-0-0-239.eu-west-1.compute.internal”,
“PrivateIpAddress”: “10.0.0.239”,
“PrivateIpAddresses”:

The code snippets of JSON representation of the above code is as follows:

```
],
  “monitoring”: false,
  “network_interface”: [ ],
  “outpost_arn”: “”,
  “password_data”: “”,
  “placement_group”: “”,
  “placement_partition_number”: null,
  “primary_network_interface_id”: “eni-010c14a083c8eaeeb”,
  “private_dns”: “ip-10-0-0-239.eu-west-1.compute.internal”,
  “private_ip”: “10.0.0.239”,
  “public_dns”:“ec2-52-208-172-72.eu-west-
1.compute.amazonaws.com”,
  “public_ip”: “52.208.172.72”,
  “root_block_device”: [
```

As clearly can be seen from the above example, the properties in the intermediate format have a different syntax from the AWS code. For example, “PrivateDnsName” versus “private_dns”.

At S340, the intermediate representation is compiled into the declarative or programming language compliant with the IaC tool. In an embodiment, S340 may include implementing a dictionary mapping between an intermediate representation to the configuration code applicable in the respective platform. It should be node that there may be a dictionary for each available pair of IaC tool and code infrastructure. For example, the pair of Terrform and AWS, the dictionary may include the following property mapping: <private_dns, PrivateDnsName>. The output code is IaC code representing the fix for the misalignment cloud, including their dependencies. As an example, the above-mentioned VPC unmanaged resource “SEVPC-SefiGis-6e8” the generated code would be:

```
resource “aws_vpc” “SEVPC-SefiGenis-6e8” {
  cidr_block  = “10.0.0.0/16”
  enable_classiclink_dns_support = false
  enable_dns_hostnames  = true
  tags = {
    Name  = “SEVPC-SefiGenis”
    environment = “se-assignment”
  }
}
```

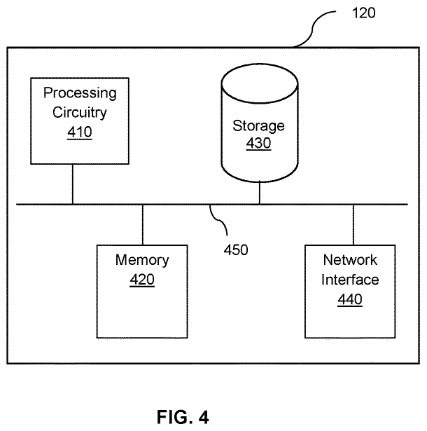

FIG. 4 is an example schematic diagram of a server 120 according to an embodiment. The server 120 includes a processing circuitry 410 coupled to a memory 420, a storage 430, and a network interface 440. In an embodiment, the components of the server 120 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., a read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the server 120 to communicate with, for example, the IaC tools, resources in the cloud infrastructure, the code repositories, and the like.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may either be part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for correcting misaligned states of cloud resources in a cloud infrastructure, comprising:
receiving a first list of cloud resources and their current operational states in a cloud infrastructure;
retrieving, from at least one IaC tool, a second list cloud resources and their deployed states;
for each cloud resource includes in the first list and second list, comparing its current operational state to its deployed state to identify a misaligned state, wherein a misaligned state of a cloud resource is when its current operational state differs from its deployed state;
for each cloud resource identified with a misaligned, generating a configuration code to fix the identified misaligned cloud resource; and
causing the IaC tool to apply the generated configuration code on each misaligned cloud resource, thereby causing the current operational state to match the deployed state of the misaligned cloud resource.

2. The method of claim 1, further comprising:
saving the generated configuration code in a code repository associated with the IaC tool.

3. The method of claim 1, wherein the generated configuration code is compatible with an IaC environment of the IaC tool.

4. The method of claim 1, further comprising:
identifying a subset of unmanaged cloud resources by comparing the cloud resources in the first list to the cloud resource in the second list, wherein unmanaged cloud resources are not managed by the at least on IaC tool.

5. The method of claim 4, further comprising:
generating the configuration code for unmanaged cloud resources; and
saving the generated configuration code in a code repository associated with the IaC tool.

6. The method of claim 1, wherein comparing the current operational state to the deployed state further comprises:
converting a representation format of a current operational state into a representation format compatible with the IaC tool; and
comparing the current state in its converted representation format to the representation format of the deployed state.

7. The method of claim 1, wherein receiving the first list of cloud resources and their current state further comprises:
scanning a cloud infrastructure to identify cloud resources and their current operational configuration.

8. The method of claim 2, wherein generating the configuration code further comprises:
mapping, for managed cloud resources, between configuration code stored in the code repository and to the deployed state managed by the at least one IaC tool; and
mapping, for managed cloud resources, between configuration code stored in the code repository and to the operation state as in the cloud infrastructure.

9. The method of claim 1, wherein generating configuration code further comprises:
analyzing the current state of a misaligned cloud resource to identify dependencies to other cloud resources; and
generating configuration for each identified dependent cloud resource.

10. The method of claim 9, wherein generating configuration code further comprises:
converting a current operational state into an intermediate representation including language constructs of a declarative language utilized by the at least one IaC tool; and
compiling the intermediate representation into the declarative language.

11. A non-transitory computer readable medium having stored thereon instructions for causing a processing circuitry to execute a process, the process comprising:
receiving a first list of cloud resources and their current operational states in a cloud infrastructure;
retrieving, from at least one IaC tool, a second list cloud resources and their deployed states;
for each cloud resource includes in the first list and second list, comparing its current operational state to its deployed state to identify a misaligned state, wherein a misaligned state of a cloud resource is when its current operational state differs from its deployed state;
for each cloud resource identified with a misaligned, generating a configuration code to fix the identified misaligned cloud resource; and
causing the IaC tool to apply the generated configuration code on each misaligned cloud resource, thereby causing the current operational state to match the deployed state of the misaligned cloud resource.

12. A system for correcting misaligned states of cloud resources in a cloud infrastructure, comprising:
a processing circuitry; and
a memory, the memory containing instructions that, when executed by the processing circuitry, configure the system to:
receive a first list of cloud resources and their current operational states in a cloud infrastructure;
retrieve, from at least one IaC tool, a second list cloud resources and their deployed states;
for each cloud resource includes in the first list and second list, compare its current operational state to its deployed state to identify a misaligned state, wherein a misaligned state of a cloud resource is when its current operational state differs from its deployed state;
for each cloud resource identified with a misaligned, generate a configuration code to fix the identified misaligned cloud resource; and
cause the IaC tool to apply the generated configuration code on each misaligned cloud resource, thereby causing the current operational state to match the deployed state of the misaligned cloud resource.

13. The system of claim 12, further comprises:
save the generated configuration code in a code repository associated with the IaC tool.

14. The system of claim 12, wherein the generated configuration code is compatible with an IaC environment of the IaC tool.

15. The system of claim 12, wherein the system is further configured to:
identify a subset of unmanaged cloud resources by comparing the cloud resources in the first list to the cloud resource in the second list, wherein unmanaged cloud resources are not managed by the at least on IaC tool.

16. The system of claim 15, wherein the system is further configured to:
generate the configuration code for unmanaged cloud resources; and
save the generated configuration code in a code repository associated with the IaC tool.

17. The system of claim 12, wherein the system is further configured to:
convert a representation format of a current operational state into a representation format compatible with the IaC tool; and
compare the current state in its converted representation format to the representation format of the deployed state.

18. The system of claim 12, wherein the system is further configured to:
scan a cloud infrastructure to identify cloud resources and their current operational configuration.

19. The system of claim 13, wherein the system is further configured to:
map, for managed cloud resources, between configuration code stored in the code repository and to the deployed state managed by the at least one IaC tool; and
map, for managed cloud resources, between configuration code stored in the code repository and to the operation state as in the cloud infrastructure.

20. The system of claim 12, wherein the system is further configured to:
analyze the current state of a misaligned cloud resource to identify dependencies to other cloud resources; and
generate configuration for each identified dependent cloud resource.

21. The system of claim 20, wherein the system is further configured to:
convert a current operational state into an intermediate representation including language constructs of a declarative language utilized by the at least one IaC tool; and
compile the intermediate representation into the declarative language.
